(19) United States
(12) Patent Application Publication
(10) Pub. No.: US 2008/0033076 A1
(43) Pub. Date: Feb. 7, 2008

(54) Olefin Polymer Composition Powder and Modified Olefin Polymer

(75) Inventors: Hiroyoshi Nakajima, Ichihara-shi (JP); Shuichi Kimata, Sodegaura-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited, Tokyo (JP)

(21) Appl. No.: 11/667,315

(22) PCT Filed: Nov. 10, 2005
(86) PCT No.: PCT/JP05/21073

§ 371 Date: May 24, 2007

(30) Foreign Application Priority Data
Nov. 12, 2004 (JP) 2004-328686

(51) Int. Cl. C08F 255/00; C08L 23/00; C08L 51/00

(52) U.S. Cl. 523/456; 524/394

(57) ABSTRACT

Disclosed is an olefin polymer composition powder having excellent powder properties which is useful as a raw material for a modified olefin polymer having high modification degree. Also disclosed is a modified olefin polymer having high modification degree obtained from such an olefin polymer composition powder. Specifically disclosed is an olefin polymer composition powder containing 100 parts by weight of an olefin polymer powder (A), 0.1-20 parts by weight of an ethylenically unsaturated bond-containing monomer (B), 0.1-20 parts by weight of an organic peroxide (C) and 0.1-20 parts by weight of an organic porous powder (D). Also specifically disclosed is a modified olefin polymer obtained by heating such a powder.

### TECHNICAL FIELD

The present invention relates to olefin polymer composition powders excellent in powder properties and to modified olefin polymers obtained therefrom.

### BACKGROUND ART

Various modified olefin polymers have been developed for improvement in the performance of olefin polymers.

For example, JP-A 5-239158 discloses, as a modified propylene polymer excellent in transparency, mechanical strength and moldability, a modified propylene polymer produced by impregnating a powdery propylene polymer with a vinyl monomer including an aromatic vinyl monomer as a main ingredient and then melt kneading them to subject the vinyl monomer to polymerization.

U.S. Pat. No. 5,411,994 discloses a particulate olefin polymer material formed by free radical-initiated graft polymerization of at least one vinyl monomer at free radical sites on a particulate olefin polymer material having a pore volume fraction, a surface area and a weight average diameter each within a specific range.

However, increase in the amount of the monomer for modification added to the olefin polymer powder in order to achieve a high degree of modification will result in deterioration of powder properties, which makes it difficult to obtain a modified olefin polymer having a desired high degree of modification.

### DISCLOSURE OF THE INVENTION

The objects of the present invention are to provide an olefin polymer composition powder excellent in powder properties which is useful as a raw material of a modified olefin polymer having a high degree of modification and to provide a modified olefin polymer having a high degree of modification prepared from the powder.

In one aspect, the present invention provides an olefin polymer composition powder comprising 100 parts by weight of 100 parts by weight of olefin polymer powder (A), from 0.1 to 20 parts by weight of ethylenically unsaturated bond-containing monomer (B), from 0.1 to 20 parts by weight of an organic peroxide (C), and from 0.1 to 20 parts by weight of organic porous powder (D).

In another aspect, the present invention provides a modified olefin polymer produced by heating the above-mentioned olefin polymer composition powder.

In still another aspect, the present invention provides a method for producing a modified olefin polymer comprising a step of heating the aforementioned olefin polymer composition powder.

According to the present invention, it is possible to obtain an olefin polymer composition powder excellent in powder properties and a modified olefin polymer produced therefrom.

### BEST MODE FOR CARRYING OUT THE INVENTION

Examples of the olefin polymer constituting the olefin polymer powder (A) used in the present invention include ethylene polymers, propylene polymers, butene polymers, polymers having moieties derived from diene compounds, and hydrogenated block copolymers.

Examples of the ethylene polymers include ethylene homopolymers, ethylene-propylene copolymers and ethylene-α-olefin copolymers.

The a-olefin in the ethylene-α-olefin copolymers is an α-olefin having 4 to 20 carbon atoms and preferable examples thereof include 1-butene, 1-pentene, 1-hexene, 1-octene and 1-decene.

Examples of the ethylene-α-olefin copolymers include ethylene-1-butene copolymers, ethylene-1-hexene copolymers and ethylene-1-octene copolymers.

Examples of the propylene polymers include propylene homopolymers, propylene-ethylene random copolymers, propylene-α-olefin random copolymers, propylene-ethylene-α-olefin random copolymers, and propylene copolymers, which are also called polypropylene block copolymers, comprising a propylene homopolymer component or copolymer component obtained by polymerizing monomers mainly comprising propylene and a copolymer component of propylene, ethylene and/or α-olefin.

Examples of the α-olefin used in the propylene-α-olefin random copolymers, propylene-ethylene-α-olefin random copolymers, and propylene copolymers comprising a propylene homopolymer component or copolymer component obtained by polymerizing monomers mainly comprising propylene and a copolymer component of propylene, ethylene and/or α-olefin include α-olefins having 4 to 20 carbon atoms, and preferable examples thereof include 1-butene, 1-pentene, 1-hexene, 1-octene and 1-decene.

Examples of the propylene-α-olefin random copolymers include propylene-1-butene random copolymers, propylene-1-hexene random copolymers and propylene-1-octene random copolymers.

Examples of the propylene-ethylene-α-olefin random copolymers include propylene-ethylene-1-butene random copolymers, propylene-ethylene-1-hexene random copolymers and propylene-ethylene-1-octene random copolymers.

Examples of the copolymer component obtained by polymerizing monomers mainly comprising propylene in the polypropylene copolymers comprising a propylene homopolymer component or copolymer component obtained by polymerizing monomers mainly comprising propylene and a copolymer component of propylene, ethylene and/or α-olefin include propylene-ethylene copolymer components, propylene-1-butene copolymers, and propylene-1-hexene components. Examples of the copolymer components of propylene, ethylene and/or α-olefin include propylene-ethylene copolymer components, propylene-ethylene-1-butene copolymer components, propylene-ethylene-1-hexene copolymer components, propylene-ethylene-1-octene copolymer components, propylene-1-butene copolymer components, propylene-1-hexene copolymer components and propylene-1-octene copolymer components.

Examples of the polypropylene copolymers comprising a propylene homopolymer component or copolymer component obtained by polymerizing monomers mainly comprising propylene and a copolymer component of propylene, ethylene and/or α-olefin include (propylene)-(propylene-ethylene) copolymers, (propylene)-(propylene-ethylene-1-butene) copolymers, (propylene)-(propylene-ethylene-1-hexene) copolymers, (propylene)-(propylene-1-butene) copolymers, (propylene)-(propylene-1-hexene) copolymers, (propylene-ethylene)-(propylene-ethylene) copolymers, (propylene-ethylene)-(propylene-ethylene-1-butene) copolymers (propylene-ethylene)-(propylene-ethylene-1-hexene) copolymers, (propylene-ethylene)-(propylene-1-butene) copolymers, (propylene-ethylene)-(propylene-1-hexene) copolymers, (propylene-1-butene)-(propylene-ethylene) copolymers, (propylene-1-butene)-(propylene-ethylene-1-butene) copolymers, (propylene-1-butene)-(propylene-ethylene-1-hexene) copolymers, (propylene-1-butene)-(propylene-1-butene) copolymers, and (propylene-1-butene)-(propylene-1-hexene) copolymers.

Examples of the butene polymers include 1-butene homopolymers.

Examples of the diene compound used in the copolymers having moieties derived from a diene compound include 1,3-butadiene, 1,4-hexadiene, dicyclopentadiene methylene norbornene and ethylidene norbornene. Examples of the polymers having moieties derived from a diene compound include ethylene-propylene-dicyclopentadiene copolymers, ethylene-propylene-ethylidene norbornene copolymers.

Examples of the hydrogenated block copolymers include hydrogenated block copolymers having at least one aromatic vinyl compound polymer block (L) and at least one conjugated diene polymer block (M) and having a structure represented by the following structural formula (1), wherein the aromatic vinyl compound polymer block content is from 15 to 85% by weight and at least 70% of the double bonds of the conjugated diene moieties have been hydrogenated:
(L-M)ₙ-L-(M-L)ₙ (1)

In structural formula (1), n is an integer from 1 to 10.

The aromatic vinyl compound polymer block (L) is a polymer comprising at least one aromatic vinyl compound selected from the group consisting of styrene, α-methylstyrene, p-ethylstyrene, 2,4-dimethylstyrene, vinylnaphthalene and vinylanthracene. It is preferably a polymer comprising at least one aromatic vinyl compound selected from styrene and α-methylstyrene, and more preferably a polymer made up of styrene.

The conjugated diene polymer block (M) is a polymer comprising at least one conjugated diene selected from the group consisting of 1,3-butadiene, isoprene, 1,3-pentadiene, 3-butyl-1,3-octadiene and 4-ethyl-1,3-hexadiene, or a polymer comprising at least one monomer selected from the group consisting of the aforementioned conjugated dienes and the aforementioned aromatic vinyl compounds. It is preferably a polymer comprising at least one monomer selected from 1,3-butadiene and isoprene.

In the case where the conjugated diene polymer block (M) is a polymer made up of 1,3-butadiene, when the polymer made up of 1,3-butadiene is hydrogenated, ethylene and butylene generate from a 1,4-bond polymerized portion and a 1,2-bond polymerized portion, respectively, resulting in an ethylene-butylene copolymer (SEBS). There are no particular limitations with respect to the ratio of butylene to ethylene in the ethylene-butylene copolymer and to the polymerization system used for the preparation of the ethylene-butylene copolymer. For example, vapor phase polymerization, solution polymerization, slurry polymerization, suspension polymerization, bulk polymerization, etc. are applicable. In view of polymerization mechanism, cationic polymerization, anionic polymerization, radical polymerization, coordinated anionic polymerization, etc. can be applied.

A preferable olefin polymer powder (A) is a powder of a propylene homopolymer, a (propylene)-(propylene-ethylene) copolymer, a (propylene)-(propylene-1-butene) copolymer, a propylene-ethylene random copolymer, a propylene-1-butene random copolymer or a propylene-ethylene-1-butene random copolymer.

The olefin polymer used in the olefin polymer powder (A) may comprise either a single kind of olefin polymer or a mixture of two or more kinds of olefin polymers.

Further, the olefin polymer powder (A) may comprise either a single kind of grains or a mixture of two or more kinds of grains differing in composition.

The ethylenically unsaturated bond-containing monomer (B) used in the present invention is a compound having at least one kind of ethylenically unsaturated bond in the molecule and/or a compound having a structure capable of being transformed due to dehydration or the like during the production process into a structure having at least one kind of ethylenically unsaturated bond in the molecule.

The ethylenically unsaturated bond-containing monomer (B) of the present invention is preferably in liquid form at 25° C., 1 atm.

Examples of the ethylenically unsaturated bond-containing monomer (B) of the present invention include aromatic vinyl monomers such as styrene, α-methylstyrene, o-methylstyrene, p-methylstyrene, m-methylstyrene, halogenated styrene, tert-butylstyrene, vinyltoluene, vinylxylene, divinylbenzene, vinylnaphthalene and vinylanthracene; and (meth)acrylates such as methyl metaacrylate.

The ethylenically unsaturated bond-containing monomer (B) of the present invention is preferably, for example, an ethylenically unsaturated bond-containing polar monomer having at least one kind of functional group selected from the group consisting of hydroxyl group, carboxyl group, epoxy group, amino group, amide group, imidazole group, pyridine group, piperidine group, silyl group, cyano group, isocyanate group and oxazoline group; an acid anhydride, ester compound, amide compound or metal salt derived from a monomer having a carboxyl group; an ester compound or metal salt derived from a monomer having a hydroxyl group; or an amide compound or metal salt derived from a monomer having an amino group.

Examples of the ethylenically unsaturated bond-containing polar monomer include hydroxyl group-containing compounds, carboxyl group-containing compounds, epoxy group-containing compounds, amino group-containing compounds, amide group-containing compounds, imidazole group-containing compounds, pyridine group-containing compounds, piperidine group-containing compounds, silyl group-containing compounds, cyano group-containing compounds, isocyanate group-containing compounds and oxazoline group-containing compounds. Preferable alternatives are hydroxyl group-containing compounds, carboxyl group-containing compounds and acid anhydrides thereof, epoxy group-containing compounds and amino group-containing compounds, and particularly preferable alternatives are hydroxyl group-containing compounds, carboxyl group-containing compounds and acid anhydrides thereof.

Examples of the hydroxyl group-containing compounds include compounds represented by the following structural formula (1) or (2): 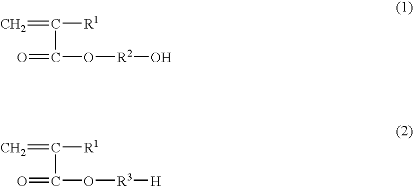
wherein in structural formula (1) or (2), R¹ represents a hydrogen atom or an alkyl group having from 1 to 6 carbon atoms and R² represents an alkylene group and/or cycloalkylene group having from 1 to 20 carbon atoms, and R³ represents (CnH₂ₙO)ₘ.

Examples of the compounds represented by the structural formula (1) or (2) include (meth)acrylates such as 2-hydroxymethyl(meth)acrylate, 2-hydroxylethyl (meth)acrylate, 2-hydroxypropyl(meth)acrylate, 2-hydroxybutyl(meth)acrylate, polyethylene glycol mono(meth)acrylate, polypropylene glycol mono(meth)acrylate, poly(ethylene glycol-propylene glycol) mono(meth)acrylate, poly(ethylene glycol-tetramethylene glycol) mono(meth)acrylate, poly(propylene glycol-tetramethylene glycol) mono(meth)acrylate and poly(propylene glycol-butylene glycol) mono(meth)acrylate.

Examples of hydroxyl group-containing compounds other than the compounds represented by the structural formula (1) or (2) include unsaturated alcohols such as allyl alcohol, 9-decen-1-ol, 10-undecen-1-ol and propargyl alcohol; vinyl ethers such as 2-hydroxyethyl vinyl ether, diethylene glycol monovinyl ether and 4-hydroxybutyl vinyl ether; allyl ethers such as 2-hydroxyethyl allyl ether; and alkenylphenols such as p-vinylphenol and 2-propenylphenol.

Examples of the carboxyl group-containing compounds include unsaturated dicarboxylic acids such as maleic acid, fumaric acid, chloromaleic acid, himic acid, citraconic acid and itaconic acid; unsaturated monocarboxylic acids such as acrylic acid, butanoic acid, crotonic acid, vinylacetic acid, methacrylic acid, pentenoic acid, dodecenoic acid, linolic acid, angelic acid and cinnamic acid; and anhydrides or alkyl esters of the aforementioned unsaturated dicarboxylic acids or unsaturated monocarboxylic acids such as maleic anhydride, himic anhydride and acrylic anhydride.

Examples of the epoxy group-containing compounds include glycidyl(meth)acrylate, (meth)acryl glycidyl ether and allyl glycidyl ether.

Examples of the amino group-containing compounds include tertiary amino group-containing (meth)acrylates such as dimethylaminomethyl(meth)acrylate, dimethylaminoethyl (meth)acrylate, dimethylaminopropyl(meth)acrylate and diethylaminoethyl(meth)acrylate; vinylmorpholines such as 4-vinylmorpholine, 2-methyl-4-vinylmorpholine and 4-allylmorpholine; tertiary amino group-containing unsaturated imide compounds which are reaction products of unsaturated carboxylic acid anhydrides, such as maleic anhydride and itaconic anhydride, with amine compounds; tertiary amino group-containing (meth)acrylamides such as dimethylaminomethyl(meth)acrylamide, dimethylaminoethyl (meth)acrylamide and dimethylaminopropyl(meth)acrylamide; tertiary amino group-containing aromatic vinyl compounds; and quaternary ammonium salt group-containing unsaturated compounds which are compounds resulting from cationization of tertiary amino group-containing unsaturated compounds, such as N,N,N-trimethyl-N-(2-hydroxy-3-methacryloyloxypropyl)ammonium chloride with cationizing agents.

Examples of the cationizing agents include alkyl halide derivatives such as methyl chloride, ethyl chloride, butyl chloride, octyl chloride, lauryl chloride, stearyl chloride, cyclohexyl chloride, benzyl chloride, phenethyl chloride, allyl chloride, methyl bromide, ethyl bromide, butyl bromide, octyl bromide, lauryl bromide, stearyl bromide, benzyl bromide, allyl bromide, methyl iodide, ethyl iodide, butyl iodide, octyl iodide, lauryl iodide, stearyl iodide and benzyl iodide; alkyl haloacetates such as methyl monochloroacetate, ethyl monochloroacetate and ethyl bromoacetate; dialkyl sulfates such as dimethyl sulfate and diethyl sulfate; inorganic acids such as hydrochloric acid, hydrobromic acid, sulfuric acid and phosphoric acid; organic acids such as formic acid, acetic acid and propionic acid; epihalohydrin adducts of tertiary amine mineral acid salts such as N-(3-chloro-2-hydroxypropyl)-N,N,N-trimethylammonium chloride.

Examples of the amide group-containing compounds include (meth)acrylamide, dimethyl(meth)acrylamide, diethyl (meth)acrylamide, N-methylol (meth)acrylamide, N-butoxy dimethyl(meth)acrylamide and N-isopropylacrylamide.

Examples of the imidazole group-containing compounds include vinylimidazoles such as 1-vinylimidazole, 2-methyl-1-vinylimidazole, 4-methyl-1-vinylimidazole, 5-methyl-1-vinylimidazole, 2-lauryl-1-vinylimidazole and 4-tert-butyl-1-vinylimidazole.

Examples of the pyridine group-containing compounds include vinylpyridines such as 2-vinylpyridine, 3-vinylpyridine, 4-vinylpyridine, 2-methyl-5-vinylpyridine, 3-methyl-5-vinylpyridine, 4-methyl-5-vinylpyridine, 6-methyl-5-vinylpyridine, 2-methyl-4-vinylpyridine, 3-methyl-4-vinylpyridine, 2-lauryl-4-vinylpyridine, 2-lauryl-5-vinylpyridine, 2-tert-butyl-4-vinylpyridine, and 2-tert-butyl-5-vinylpyridine.

Examples of the piperidine group-containing compounds include vinylpiperizines such as 1-vinylpiperidine and 4-methyl-4-vinylpiperidine; and vinylpiperazines such as 2-lauryl-1-vinylpiperazine and 4-methylpiperazino ethyl (meth)acrylate.

Examples of the silyl group-containing compounds include vinyltrimethoxysilane, vinyltriethoxysilane, vinyltributoxysilane, 3-methacryloxypropyltrimethoxysilane, 3-methacryloxypropylmethyldimethoxysilane, 3-methacryloxypropylmethyldiethoxysilane, 3-acryloxypropyltrimethoxysilane, p-styryltrimethoxysilane, and vinyltris(2-methoxyethoxy)silane.

Examples of the cyano group-containing compounds include (meta)acrylonitrile.

Examples of the isocyanate group-containing compounds include (meth)acryloyl isocyanate, crotyl isocyanate, crotonic acid isocyanate ethyl ester, crotonic acid isocyanate butyl ester, crotonic acid isocyanate ethyl ethylene glycol, crotonic acid isocyanate ethyl diethylene glycol, crotonic acid isocyanate ethyl triethylene glycol, (meth)acrylic acid isocyanate ethyl ester, (meth)acrylic acid isocyanate butyl ester, (meth)acrylic acid isocyanate hexyl ester, (meth)acrylic acid isocyanate octyl ester, (meth)acrylic acid isocyanate lauryl ester, (meth)acrylic acid isocyanate hexadecyl ester, (meth) acrylic acid isocyanate ethylene glycol, (meth)acrylic acid isocyanate ethyl diethylene glycol and (meth)acrylic acid isocyanate ethyl triethylene glycol.

Examples of the oxazoline group-containing monomers include 2-vinyl-2-oxazoline, 2-vinyl-4-methyl-2-oxazoline, 2-isopropenyl-2-oxazoline, and 2-isopropenyl-4-oxazoline. The amount of the ethylenically unsaturated bond-containing monomer (B) added is from 0.1 to 20 parts by weight, preferably from 0.5 to 15 parts by weight, and even more preferably from 1 to 15 parts by weight per 100 parts by weight of the olefin polymer powder (A). When the amount of the monomer (B) added is too small, the amount of the monomer (B) grafted in the modified olefin polymer obtained from the olefin polymer composition powder may become small. When the amount of the monomer (B) added is too large, the powder properties of the olefin polymer composition powder may worsen and a large portion of the monomer (B) may remain unreacted in the modified olefin polymer obtained by heating the olefin polymer composition powder. For example, when the resulting modified olefin polymer is used for bonding, a sufficient bonding strength may not be achieved.

The organic peroxide (C) used in the present invention may be conventional organic peroxides, examples of which include organic peroxides the half life of which becomes one minute at a temperature lower than 120° C. Examples of such organic peroxides include diacylperoxide compounds, percarbonate compounds (compounds (I) having a structure represented by the following structural formula (3) in the molecular skeleton) and alkyl perester compounds (compounds (II) having a structure represented by the following structural formula (4) in the molecular skeleton).

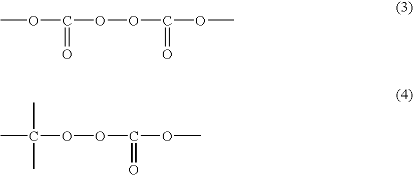

Examples of the compound (I) represented by structural formula (3) include di-3-methoxybutyl peroxydicarbonate, di-2-ethylhexyl peroxydicarbonate, bis(4-tert-butylcyclohexyl)peroxydicarbonate, diisopropyl peroxydicarbonate, tert-butylperoxyisopropyl carbonate and dimyristyl peroxycarbonate. Examples of the compounds (II) represented by structural formula (4) include 1,1,3,3-tetramethylbutyl neodecanoate, α-cumylperoxy neodecanoate and tert-butylperoxy neodecanoate.

Organic peroxides, the half life of which becomes one minute at a temperature not lower than 120° C. may also be used. Examples thereof include 1,1-bis(tert-butylperoxy)cyclohexane, 2,2-bis(4,4-di-tert-butylperoxycyclohexyl)propane, 1,1-bis(tert-butylperoxy)cyclododecane, tert-hexylperoxyisopropyl monocarbonate, tert-butylperoxy-3,5,5-trimethyl haxonoate, tert-butyl peroxylaurate, 2,5-dimethyl-2,5-di-(benzoylperoxy)hexane, tert-butylperoxy acetate, 2,2-bis(tert-butylperoxy)butene, tert-butylperoxy benzoate, n-butyl-4,4-bis(tert-butylperoxy) valerate, di-tert-butylperoxyisophthalate, dicumyl peroxide, α-α′-bis(tert-butylperoxy-m-isopropyl)benzene, 2,5-dimethyl-2,5-di(tert-butylperoxy)hexane, 1,3-bis(tert-butylperoxydiisopropyl)benzene, tert-butylcumyl peroxide, di-tert-butyl peroxide, p-menthane hydroperoxide, and 2,5-dimethyl-2,5-di-(tert-butylperoxy)hexine-3.

The amount of the organic peroxide (C) added is from 0.01 to 20 parts by weight, and preferably from 0.03 to 1.0 parts by weight based on 100 parts by weight of the olefin polymer (A). When the amount of the organic peroxide (C) added is too small, the amount of the monomer (B) grafted in the modified olefin polymer obtained from the olefin polymer composition powder may become small. When the amount of the organic peroxide (C) is too large, decomposition of the olefin polymer powder may be promoted too much during the production of the modified olefin polymer.

The organic porous powder (D) used in the present invention is a powder of porous organic polymer. The organic porous powder (D) preferably has a specific surface area from 0.1 to 1000 m²/g, a porosity from 5 to 90% and an average particle diameter from 1 to 7000 μm, and more preferably has a pore diameter within the range from 0.05 to 10 μm.

The specific surface area of the organic porous powder (D) is more preferably from 10 to 800 m²/g, and even more preferably from 30 to 300 m²/g. The porosity of the organic porous powder is more preferably from 30 to 85%, and even more preferably from 50 to 85%.

The organic porous powder (D) does not dissolve in the ethylenically unsaturated bond-containing monomer (B) or the organic peroxide (C).

Examples of the material of the organic porous powder (D) generally include α-olefin polymers such as ethylene polymers, propylene polymers, butene polymers, ethylene-propylene copolymers, ethylene-butene-1 copolymers, ethylene-hexene-1 copolymers, propylene-butene-1 copolymers, propylene-hexene-1 copolymers and propylene-divinylbenzene copolymers; aromatic unsaturated hydrocarbon polymers such as polystyrene and styrene-divinylbenzene copolymers; polar group-containing polymers such as polyacrylic esters, polymethacrylic esters, polyacrylonitrile, polyvinyl chloride, polyamide, polyphenylene ether, polyethylene terephthalate and polycarbonate.

The organic porous powder (D) can be produced by treating polymer particles with a solvent having a moderate ability to dissolve the polymer, thereby forming pores. Such organic porous powders are commercially available. For example, various grades of products available under the commercial name “Accurel” from MEMBRANA can be used.

The olefin polymer composition powder of the present invention may contain additives and fillers. Examples of such additives include antioxidants, neutralizing agents, weathering agents, UV absorbers, copper inhibitors, lubricants, processing aids, plasticizers, dispersing agents, antiblocking agents, antistatic agents, nucleating agents, flame retardants, foaming agents, foam inhibitors, crosslinking agents and colorants. Examples of fillers include glass fiber, carbon fiber, metal fiber, glass beads, mica, granular or tabular calcium carbonate, potassium titanate whisker, talc, fibrous magnesium oxysulfate, aramid fiber, granular or tabular barium sulfate, glass flake and fibrous fluororesin.

The olefin polymer composition powder of the present invention can be produced by conventionally known methods. One example of preferred embodiments is a method in which the ingredients are added at the same time or stepwise and mixed in a mixer such as Henschel mixer, ribbon blender and blender to yield a uniform mixture.

The modified olefin polymer of the present invention is obtained by heating the olefin polymer composition powder of the present invention. The amount of ethylenically unsaturated bond-containing monomers grafted in the modified olefin polymer is from 0.05 to 20% by weight, preferably from 0.5 to 15% by weight, and even more preferably from 1 to 12% by weight, wherein the whole amount of the modified olefin polymer is 100% by weight.

The intrinsic viscosity [η] of the modified olefin polymer of the present invention measured in tetralin at 135° C. is preferably from 0.5 to 2 dl/g, and more preferably from 0.7 to 1.5 dl/g. The intrinsic viscosity of the modified olefin polymer can be adjusted by properly adjusting the quantity of the organic peroxide (C) used for the modification and the intrinsic viscosity of the olefin polymer powder (A).

The molecular weight distribution of the modified olefin polymer of the present invention measured by gel permeation chromatography (GPC) is preferably from 2 to 8, more preferable from 2.5 to 6, and even more preferably from 3 to 6. As well known in the art, the molecular weight distribution is a ratio of the weight-average molecular weight Mw to the number-average molecular weight Mn, i.e., Mw/Mn, and is also called a Q value. The molecular weight distribution of the modified olefin polymer can be adjusted by properly adjusting the molecular weight distribution of the olefin polymer powder (A) used for the modification.

Further, the melting peak temperature Tₘ in a temperature programmed thermogram of the modified polyolefin polymer of the present invention measured with a differential scanning calorimeter is preferably from 130 to 170° C., more preferably from 140 to 165° C., and even more preferably from 150 to 165° C.

The modified olefin polymer of the present invention can be produced by heating the olefin polymer composition powder of the present invention by use of conventionally known methods. For example, a solution method comprising heating an olefin polymer composition powder of the present invention in an organic solvent and a melt kneading method comprising melt kneading an olefin polymer composition powder of the present invention by use of a melt kneading machine such as extruder.

A method preferably used is one which comprises melt kneading an olefin polymer composition powder of the present invention. As the means for the melt kneading, conventional melt kneading machines such as Banbury mixer, plastomill, Brabender plastograph, and single or twin screw extruder can be used. A single or twin screw extruder is preferred. The melt kneading machine may have a feeding port or alternatively may have two or more feeding ports so that raw materials can be fed stepwise. The temperature of the kneading section of the melt kneading machine (for example, the cylinder temperature of an extruder) is preferably from 50 to 300° C. and more preferably from 100 to 250° C. It is permitted to divide the kneading section of the melt kneading machine into two sections, namely, an upstream section and a downstream section, and set the temperature in the downstream section to be higher than that in the upstream section. The kneading time is typically from 0.1 to 30 minutes, and preferably from 0.5 to 5 minutes.

### EXAMPLES

The present invention is described below with reference to examples and comparative examples.

The physical properties of the olefin polymer composition powders and modified olefin polymers used in the examples and comparative examples were measured in accordance with the methods described below.

(1) Powder Properties of Olefin Polymer Composition Powder

An olefin polymer composition powder was charged into a hopper of an extruder, and the degree of adhesion of the powder to the wall of the hopper was taken as the powder property, which was evaluated in accordance with the following criteria:

when the degree of adhesion was high, the powder property was judged as being poor and indicated by symbol “x” in Table 1;

when the degree of adhesion was low, the powder property was judged as being good and indicated by symbol “∘” in Table 1; and

when substantially no adhesion was observed, the powder property was judged as being excellent and was indicated by symbol “⊙” in Table 1.

(2) Amount of Ethylenically Unsaturated Bond-Containing Monomers Grafted (Unit: % by Weight)

A sample was dissolved in boiling xylene and the resulting solution was dropped into a large volume of methanol under stirring, and thereby the resulting precipitate was collected. The precipitate collected was vacuum dried (80° C., 8 hours) and shaped into a 100-μm thick film by heat pressing. The film was subjected to measurement of IR absorption spectrum and the amount of ethylenically unsaturated bond-containing monomers grafted was determined on the basis of the absorption near 1730 cm⁻¹.

(3) Intrinsic Viscosity ([μ], unit: dl/g)

The intrinsic viscosities of polymer materials were measured using an Ubbelohde viscometer. The intrinsic viscosity of a propylene homopolymer was measured at a temperature of 135° C. using tetralin as a solvent.

(4) Molecular Weight Distribution (Q Value, Mw/Mn)

Measurement was conducted under the following conditions by gel permeation chromatography (GPC).

Instrument: Model 150CV (manufactured by Millipore Waters)

Column: Shodex M/S 80

Measurement temperature: 145° C.

Solvent: o-Dichlorobenzene

Sample concentration: 5 mg/8 mL

A calibration curve was produced using a standard polystyrene. The Mw/Mn of the standard polystyrene (NBS706: Mw/Mn=2.0) measured under such conditions was 1.9 to 2.0.

(5) Melting peak temperature (Tₘ, unit: ° C.)

Using a differential scanning calorimeter (DSC-7 manufactured by PerkinElmer, Inc.), a sample was heated at 220° C. for 5 minutes and the cooled to 150° C. at a rate of 300° C./min and held at 150° C. for one minute. The sample was further cooled to 50° C. at a rate of 5° C./min and held at 50° C. for one minute. The sample was further heated from 50° C. to 180° C. at a rate of 5° C./min and a melting peak temperature Tₘ was determined.

Materials used in the examples and comparative examples are shown below.

(A) PP: Olefin Polymer Powder

Propylene homopolymer, [η]: 3 dl/g, prepared by a gas phase polymerization process using the solid catalyst component disclosed in U.S. Pat. No. 5,608,018.

(B) HEMA: ethylenically unsaturated bond-containing monomer

2-Hydroxyethyl methacrylate (made by Tokyo Chemical Industry Co., Ltd.)

(C) Kb-B: Organic Peroxide

tert-Butyl peroxybenzoate (KAYABUTYL B, made by Kayaku Akzo Corp.)

(D) MP-1000: organic porous powder

MP-1000 made by MEMABRANA:

(E) NA-11

Sodium

2,2′-methylene-bis-(4,6-di-tert-butylphenylene)phosphate (ADK STAB NA-11, made by ADEKA Corp.)

### Examples 1 to 5, Comparative Examples 1 to 3

Olefin polymer composition powders were prepared by mixing PP, HEMA, Kb-B, MP-1000, NA-11 and various stabilizers (IRGANOX1010 made by Ciba Specialty Chemicals, IRGAFOS168 made by Ciba Specialty Chemicals) uniformly. The compounding ratios and powder properties of the resulting composition powders are shown in Table 1.

Modified propylene polymers were prepared by melt kneading the olefin polymer composition powders at a temperature of 180° C. and a screw rotation speed of 500 rpm by use of a twin-screw kneading extruder (commercial name: KZW15-45MG, co-rotating screw, 15 mm×45 L/D, made by Technovel Corp.). Physical properties of the resulting modified propylene polymers are shown in Table 1.

The powders of Examples 1 to 5 exhibited substantially no adhesion to the hopper of the extruder and, therefore, were good in powder property.

On the other hand, the powders of Comparative Examples 1 to 3 obtained by use of no organic porous powder exhibited high degrees of adhesion to the hopper of the extruder and, therefore, were insufficient in powder property.

TABLE 1

| | | | | | | | Amount of | | | |
|---|---|---|---|---|---|---|---|---|---|---|
| | | | | | | | (B) | | | |
| | Compounding ratio (phr) | | | | | Powder | grafted | [η] | | Tm |
| | (A) | (B) | (C) | (D) | (E) | property | (wt %) | (dl/g) | Mw/Mn | (° C.) |
| Example 1 | 100 | 6 | 1.5 | 3 | 0 | ⊙ | 1.41 | 0.87 | 2.7 | — |
| Example 2 | 100 | 8 | 1.5 | 3 | 0.3 | ◯ | 1.45 | 0.89 | 2.6 | 159.3 |
| Example 3 | 100 | 8 | 2.0 | 3 | 0.3 | ◯ | — | 0.80 | 2.6 | — |
| Example 4 | 100 | 10 | 1.5 | 3 | 0.3 | ◯ | 1.67 | 0.82 | 2.6 | 158.0 |
| Example 5 | 100 | 12 | 1.5 | 5 | 0.3 | ◯ | 1.92 | 0.85 | 2.7 | 158.5 |
| Comparative | 100 | 6 | 1.5 | 0 | 0 | X | 1.40 | 0.96 | 2.8 | 155.3 |
| Example 1 | | | | | | | | | | |
| Comparative | 100 | 8 | 1.5 | 0 | 0.3 | X | 1.51 | 0.91 | 2.6 | — |
| Example 2 | | | | | | | | | | |
| Comparative | 100 | 8 | 2.0 | 0 | 0.3 | X | — | 0.80 | 2.7 | — |
| Example 3 | | | | | | | | | | |

1. An olefin polymer composition powder comprising 100 parts by weight of an olefin polymer powder (A), from 0.1 to 20 parts by weight of ethylenically unsaturated bond-containing monomer (B), from 0.1 to 20 parts by weight of an organic peroxide (C), and from 0.1 to 20 parts by weight of an organic porous powder (D).

2. The olefin polymer composition powder according to claim 1, wherein the ethylenically unsaturated bond-containing monomer (B) is a monomer in liquid form at 25° C., 1 atm.

3. The olefin polymer composition powder according to claim 1 or 2, wherein the ethylenically unsaturated bond-containing polar monomer (B) has at least one kind of functional group selected from the group consisting of hydroxyl group, carboxyl group, epoxy group, amino group, amide group, imidazole group, pyridine group, piperidine group, silyl group, cyano group, isocyanate group and oxazoline group.

4. The olefin polymer composition powder according to claim 1, wherein the organic porous powder (D) has a specific surface area from 0.1 to 1000 m²/g, a porosity from 5 to 90% and an average particle diameter from 1 to 7000 μm.

5. A modified olefin polymer produced by heating the olefin polymer composition powder according to claim 1.

6. A method for producing a modified olefin polymer comprising a step of heating an olefin polymer composition powder comprising 100 parts by weight of an olefin polymer powder (A), from 0.1 to 20 parts by weight of an ethylenically unsaturated bond-containing monomer (B), from 0.1 to 20 parts by weight of an organic peroxide (C), and from 0.1 to 20 parts by weight of an organic porous powder (D).

7. The olefin polymer composition powder according to claim 2, wherein the organic porous powder (D) has a specific surface area from 0.1 to 1000 m²/g, a porosity from 5 to 90% and an average particle diameter from 1 to 7000 μm.

8. The olefin polymer composition powder according to claim 3, wherein the organic porous powder (D) has a specific surface area from 0.1 to 1000 m²/g, a porosity from 5 to 90% and an average particle diameter from 1 to 7000 μm.

9. A modified olefin polymer produced by heating the olefin polymer composition powder according to 2.

10. A modified olefin polymer produced by heating the olefin polymer composition powder according to 3.

11. A modified olefin polymer produced by heating the olefin polymer composition powder according to 4.
